(19) United States
(12) Patent Application Publication
(10) Pub. No.: US 2013/0096997 A1
(43) Pub. Date: Apr. 18, 2013

(54) System and Method for Enhanced Shopping

(71) Applicant: Shmuel Zalman Benedikt, Modiin Ilit (IL)

(72) Inventor: Shmuel Zalman Benedikt, Modiin Ilit (IL)

(21) Appl. No.: 13/703,952

(22) PCT Filed: Jun. 13, 2011
(86) PCT No.: PCT/IL2011/000467

§ 371 Date: Dec. 13, 2012

Related U.S. Application Data
(60) Provisional application No. 61/354,224, filed on Jun. 13, 2010.

(51) Int. Cl. G06Q 30/06

(52) U.S. Cl. CPC G06Q 30/0601
USPC 705/14.4; 705/26.8; 705/26.2; 705/18

(57) ABSTRACT

The present invention comprises a system and method for remote shopping. A user connects to a networked system by means of a cellphone, PDA, personal computer, telephone, or the like. The networked system comprises a database of merchants, merchant locations, stocked items, available items, item prices, customers, customer locations, customer histories, delivery options, timing options, stored orders, executed orders, and associated data. By means of the networked system, a customer can browse items by availability, price, merchant, and the like, and carry out orders including payment and delivery terms. Order aggregation is implemented, whereby multiple users can aggregate items over time into a shared stored order, which is fmalized, paid for, and sent.

### FIELD OF THE INVENTION

The present invention relates to a device and method for remote shopping, including provision for browsing, payment, delivery, and order consolidation.

### BACKGROUND OF THE INVENTION

U.S. Pat. No. 7,386,485 uses the mobile phone as a point-of-sale device, providing offers and information to the user concerning possible purchases. Similarly, U.S. application Ser. No. 11/512,958 provides methods for personal shopping including generation of a shopping list and connection to a communications network, and a product usage repository that contains customer information. Product information is received for each item on the shopping list from one or more product providers via the network and communicated to the customer via the network.

However these and other systems disclosed in the prior art do not disclose means for determining item availability, item cost, delivery method, repeat orders, or order concatenation.

Hence, an improved method for remote shopping is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a shared buy list;

FIG. 2 presents a strikepoint list;

FIG. 3 presents a recommended item list;

FIGS. 4a,b present system diagrams of the invention;

FIG. 5 presents a flow chart of the invention.

### SUMMARY OF THE INVENTION

The present invention comprises a system and method for remote shopping. A user connects to a networked system by means of a cellphone, PDA, personal computer, telephone, or the like. The networked system comprises a database of merchants, merchant locations, stocked items, available items, item prices, customers, customer locations, customer histories, delivery options, timing options, stored orders, executed orders, and associated data. By means of the networked system, a customer can browse items by availability, price, merchant, and the like, and carry out orders including payment and delivery terms. Order aggregation is implemented, whereby multiple users can aggregate items over time into a shared stored order, which is finalized, paid for, and sent, in keeping with various criteria.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a remote shopping system.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g, 1,5, or 10.

Conventional shopping suffers from certain drawbacks, including time required, travel required, uncertainty as to item availability and item price, vendor location, vendor status (such as open or closed), possible difficulty in remembering all required items, time required to perform even cursory comparison shopping, unnecessary impulse buys, and others.

The present invention solves all of these problems by means of a remote shopping system and method. A user connects to a networked system by means of a cellphone, PDA, personal computer, telephone, dedicated device or the like. The networked system comprises a database of merchants, merchant locations, stocked items, available items, item prices, item locations, customers, customer locations, customer histories, favorite lists, shared lists, delivery options, timing options, stored orders, executed orders, and associated data. Various data items may be updated by the system operator, vendor, and customer. For example vendors may update their lists of stocked items, available items, item prices, and item/merchant locations. Customers may similarly update their locations, desired delivery mode(s), favorite lists (lists of favorite items), strikepoint lists (lists of items and prices below which triggers are activated, such as alerts sent to the user that a particular item is available at or below a certain price, or automatic purchases when a particular items is available at or below a certain price). The system operator may add or remove merchants, change permissions controlling which entities can update which fields, and the like. All of these updates can be accomplished through a variety of means, including regular phone, cellphone, PDA, personal computer, or in principle any other networked device. These devices may be used to transmit information through a phone dialpad, SMS, email, web browser, or custom interface.

A browsing and ordering system is provided in communication with the database described above. By means of the browsing/ordering system, a customer can browse, select, and hotlist items by availability, price, merchant, and other parameters including but not limited to brand, warranty terms, consumer report ratings, other rating systems, physical characteristics, and service terms. Hotlisted items may be added to other lists such as favorites lists, shared lists, and strikepoint lists. The browsing and ordering system may also be used to confirm and carry out orders, including provision for payment and delivery terms.

Aggregation

Order aggregation is implemented by the system, whereby multiple users can aggregate items over time into a shared stored order, which is finalized, paid for, and sent, in keeping with various criteria. Thus for example a shared list may have a number of users (e.g. all members of a family) and a number of managers (e.g. the parents of the family). All users may add items to the shared list, while the list managers can also remove or forbid items. The list managers also can carry out the order or give permission to users to carry out the order. Payment may be divided and distributed automatically amongst list users, or may be limited to one or more specific users or managers, or may be divided by individual order (each user pays for what he/she added to the list), or otherwise. Obviously economies of scale may be enjoyed by such aggregation, where larger orders may be made and discounts thereby enjoyed. For example all families in a block or neighborhood may join together in a single shared weekly grocery list, with the larger order being worth the time required to de-aggregate the order due to the savings enjoyed from the larger-scale purchase.

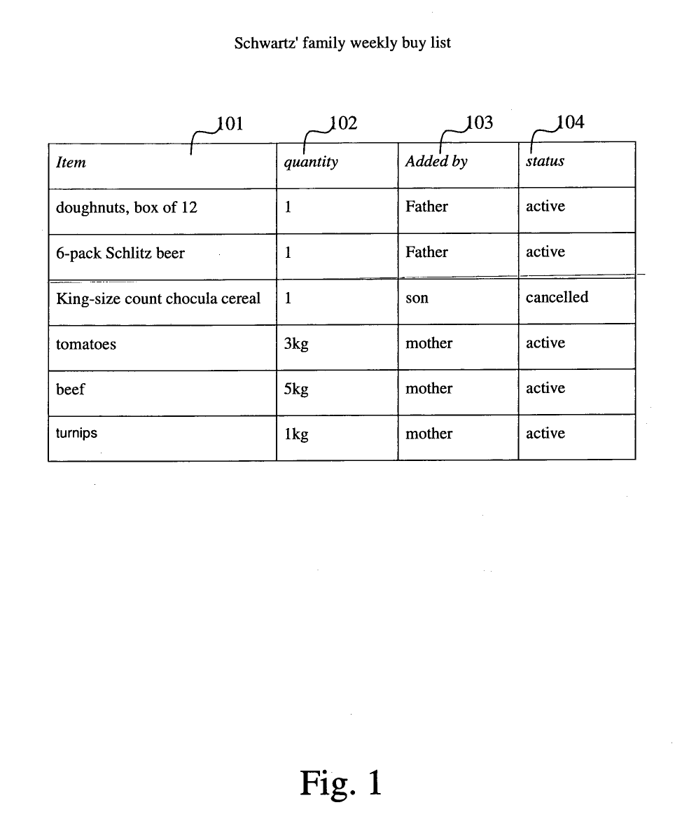

For example, see the list of FIG. 1. Here a shared list is added to by various family members. Each family member adds items on their own time and possibly from different locations and/or devices; for example the mother might add from a regular land phone, the son from a netbook, and the father from a web-enabled cellphone. Information on the list includes item name, description or other identifier 101, quantity 102, name of the party adding the item 103, and the current status 104.

It is further within provision of the invention to use supplier aggregation; in the event that one supplier does not have all items of a given, different items may be supplied by different merchants. In this way for example users may specify purchase of the cheapest possible supplier of a given item in a given geographical or delivery region. By this means automatic comparison shopping is implemented without effort on the user's part.

Strikepoint List

The system allows for the creation and maintenance of strikepoint lists, which are lists of items, associated conditions, and associated actions. of items and prices below which triggers are activated, such as alerts sent to the user that a particular item is available at or below a certain price, or automatic purchases when a particular items is available at or below a certain price).

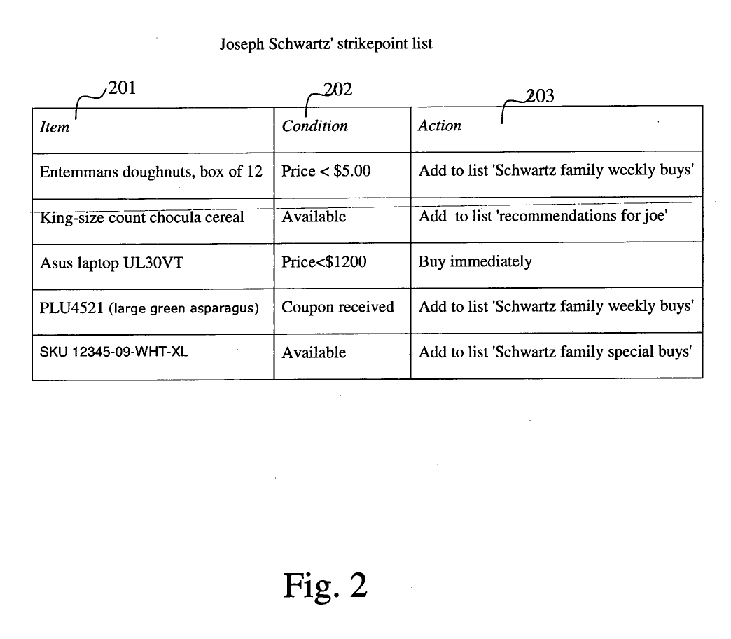

An example of a strikepoint list is shown in FIG. 2. A list of items 201 is shown, each having a condition 202 and an action 203 to take on fulfillment of the condition. Conditions may take the form (for example) of price being less than a certain amount, or that an item is available. Conditions may be compound, for instance that item A is available and item B is less than a certain price, allowing for complex conditions to be satisfied (e.g. such that ingredients for a cake will be bought if and only if all ingredients are available). Actions to take upon fulfillment of the condition(s) include adding to one's own buy list, immediate purchase, adding to someone else's recommended list, etc.

Recommended List

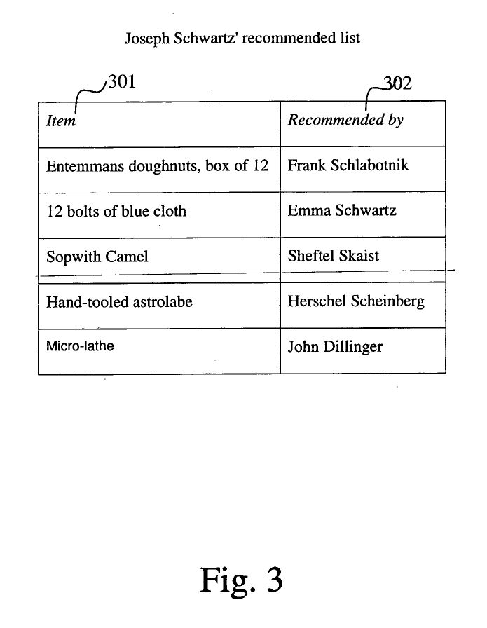

It is within provision of the invention to provide a list of items recommended by other users of the system. Thus one user can add an item to someone else's recommended list, if (for example) the owner of the list allows that person permission to recommend. An example of such a list is shown in FIG. 3, where the item 301 is identified as well as who has recommended it 302.

Payment

Once a list is sent for purchase, payment transactions must take place. It is within provision of the invention that user pay simply by means of credit card, by on-site credit, money transfer, barter, or any other method the system operator chooses to employ.

Delivery

Once a list has been sent for fulfillment, the items must be delivered from their respective vendors. Thus it is within provision of the invention that the central server of the invention send purchase orders or requests to various vendors, who then fulfill the purchases by send the items either to the purchaser or to a central or distributed fulfillment center. Delivery cost may be added to the total cost of an order. Different delivery options may be specified by the user, such as rapid delivery for crucial items; different delivery options may of course be priced differently. In one embodiment of the invention, the client can chose which of the products are urgent, and receive them as fast as the merchant can supply them, even if this means higher costs for the client.

Structure

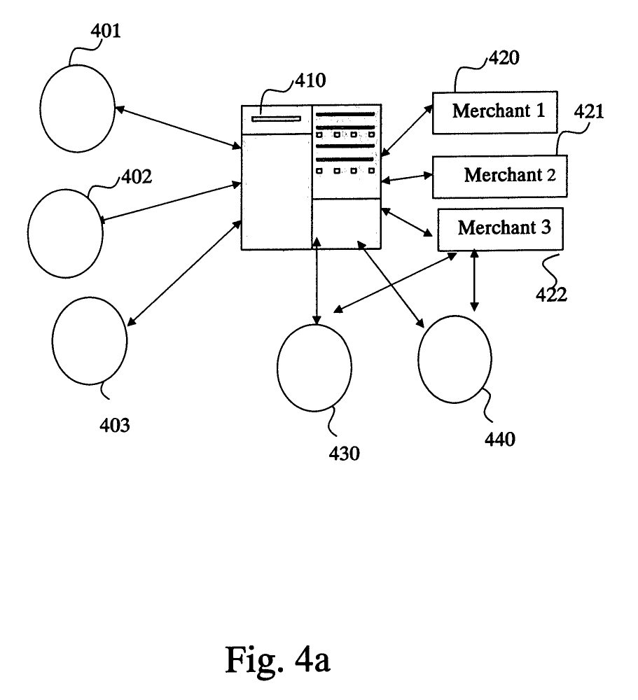

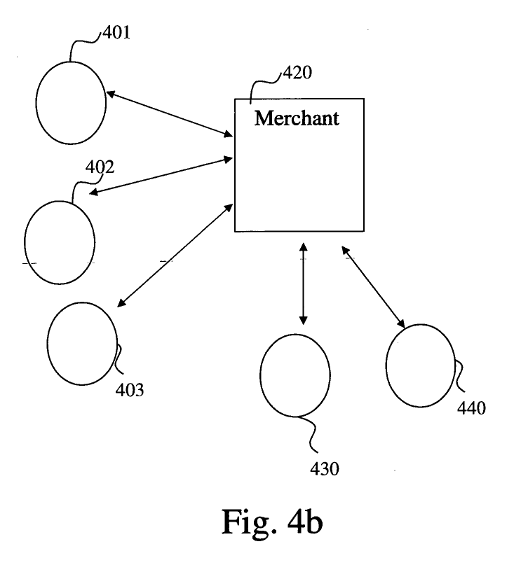

One embodiment of the overall system structure of the invention is shown in FIG. 4a. Here a number of user devices including a laptop 401, telephone 402, desktop computer 403, and cellphone 404 communicate with central server 410. This server is further in communication with merchants 420, 421, 422. Users maintain their various lists, which are stored on the server 410 for example in a database reserved for this purpose. The merchants provide stocking, availability, pricing, and location data to the server 410, which also stores this data in the same or another database. Order payment is accomplished by suitable means including but not limited to putting the server 410 into financial communication with bank or credit company 430. Alternatively, the payment may be drawn by the merchant 422, who is for this purpose in communication with bank or credit company 430. Once payment is finished, the delivery is consolidated and sent by delivery means 440. This may be instigated either by the server 410, or by one or more merchants 422.

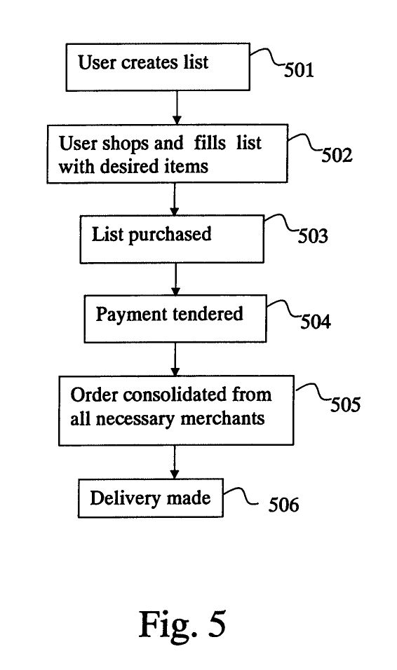

A representative flow chart showing an example of operation of one embodiment of the invention is shown in FIG. 5. In this example, a user first creates a list 501, then fills this list with a set of desired items by ‘shopping’ (selecting and buying items) remotely, which in practice involves browsing through a set of data concerning available items, prices, and associated data. After finishing such a list, the list is purchased 503 and payment tendered 504. Once paid for, the order is consolidated (from multiple vendors, if necessary) 505, and delivered 506.

In another embodiment of the invention, a standalone device is provided that recognizes the client (for example by some combination of ID number, credit card details, name, address, and a code issued by the merchant). This device is associated with one and only one merchant, who may have a network of shops (i.e. a chain of grocery stores), allowing the client to remote order products directly. The merchant can “push” information, such as coupons, special sales and advertisements directly to the dedicated device. This device can be client-specific or contain client-specific data, as the merchant knows the purchasing history of each specific client.

Such an embodiment is depicted by way of example in FIG. 4b. Again a number of user devices including a laptop 401, telephone 402, desktop computer 403, and cellphone 404 communicate with central server (not shown) maintained by merchant 420. Users maintain their various lists, which are stored on the server for example in a database reserved for this purpose. The merchant provides stocking, availability, pricing, and location data to the various users of the system. Payment is accomplished by suitable means including but not limited to putting the merchant into financial communication with bank or credit company 430. Once payment is finished, the delivery is consolidated (if need be from several stores belonging to the same merchant, e.g. a chain of grocery stores) and sent by delivery means 440.

1-18. (canceled)

19. A method for remote shopping consisting of the steps:
a. providing a networked server having a database and communication means;
b. obtaining product data from a set of merchants and storing this data in said database;
c. obtaining customer data from a set of customers and storing this data in said database;
d. creating lists of items to purchase by means of browsing said product data;
e. requiring said users to pay for items on said list by use of payment means;
f. delivering said purchased items to said customers by transport means;
wherein said product data is selected from the group consisting of: product availability, merchant locations, number of stocked items, product prices, product locations, product expiration dates, and product creation dates, and further wherein said lists of items to purchase are selected from the group consisting of: lists of items to purchase, strikepoint lists, favorites lists, and recommended lists.

20. The method of claim 19, wherein said customer data is selected from the group consisting of: customer identification, customer location, customer history, customer credit history customer favorite lists, customer shared lists, customer delivery options, customer timing options, customer stored orders, and customer executed orders.

21. The method of claim 19, wherein said server's communication means are selected from the group consisting of: landline telephony, cellular telephony, SMS messaging, internet connectivity, LAN connectivity, WAN connectivity, wireless connectivity, and packet radio.

22. The method of claim 19, wherein said purchased items are consolidated from more than one merchant.

23. The method of claim 19, wherein said lists of items to purchase are consolidated from more than one customer.

24. A system for remote shopping consisting of:
a. a networked server having a database and communication means;
b. product data obtained from a set of merchants, said product data stored in said database;
c. customer data obtained from a set of customers, said customer data stored in said database;
d. lists of items to purchase created by customers by means of browsing said product data;
e. payment means allowing said users to pay for items on said lists;
f. delivery means adapted to deliver said items to said customers;
wherein said product data is selected from the group consisting of: product availability, merchant locations, number of stocked items, product prices, product locations, product expiration dates, and product creation dates, and further wherein said lists of items to purchase are selected from the group consisting of: lists of items to purchase, strikepoint lists, favorites lists, and recommended lists.

25. A standalone device adapted for remote shopping consisting of:
a. identification means adapted to identify the user of said device;
b. communication means linking said device and a merchant;
c. selection means allowing said user to select items for purchase from said merchant;
d. payment means adapted to allow said user to purchase said items from said merchant.

26. The device of claim 25, wherein said merchant can send sales information directly to said standalone device.

27. The device of claim 26, wherein said sales information is selected from the group consisting of: coupons, special sales, and advertisements.

28. The device of claim 25, wherein said identification means is selected from the group consisting of: ID number, credit card details, name, address, a code issued by said merchant, and combinations thereof

29. The system of claim 24 or 25, wherein said product data is selected from the group consisting of: product availability, merchant locations, number of stocked items, product prices, product locations, product expiration dates, and product creation dates.

30. The system of claim 24 or 25, wherein said customer data is selected from the group consisting of: customer identification, customer location, customer history, customer credit history customer favorite lists, customer shared lists, customer delivery options, customer timing options, customer stored orders, and customer executed orders.

31. The system of claim 24 or 25, wherein said server's communication means are selected from the group consisting of: landline telephony, cellular telephony, SMS messaging, internet connectivity, LAN connectivity, WAN connectivity, wireless connectivity, and packet radio.

32. The system of claim 24 or 25, wherein said lists of items to purchase are selected from the group consisting of: lists of items to purchase, strikepoint lists, favorites lists, and recommended lists.

33. The system of claim 24 or 25, wherein said purchased items are consolidated from more than one merchant.

34. The system of claim 24 or 25, wherein said lists of items to purchase are consolidated from more than one customer.
